(19) United States
(12) Patent Application Publication
(10) Pub. No.: US 2008/0190672 A1
(43) Pub. Date: Aug. 14, 2008

(54) Method to Automatically Synchronizing Scale Database Information

(75) Inventors: David S. Miller, Troy, OH (US); Carla A. Monnier, Vandalia, OH (US); Santos Juan-Castellanos, Springfield, OH (US); Lawrence A. Pevoar, Miamisburg, OH (US)

Correspondence Address: THOMPSON HINE LLP;Intellectual Property Group, P.O Box 8801, DAYTON, OH, 45401-8801, US

(73) Assignee: Premark FEG L.L.C., Wilmington (DE)

(21) Appl. No.: 12/025,948

(22) Filed: Feb. 5, 2008

Related U.S. Application Data
(60) Provisional application No. 60/888,854, filed on Feb. 8, 2007.

(51) Int. Cl. G01G 19/40

(52) U.S. Cl. 177/25.15

(57) ABSTRACT

A method of receiving product pricing errors within a store including multiple food product scales is provided. The method includes (a) providing a store scale communications network. At step (b), a primary food product scale is provided in the store including memory for storing product pricing data. At step (c), a secondary food product scale is provided in the store including memory for storing product pricing data. At step (d), food product pricing data is communicated to the primary food product scale via the communications network and the food product pricing data is stored in memory of the primary food product scale. At step (e), the secondary food product scale identifies a potential internal product pricing data error condition and responsively requests accurate product pricing data from the primary food product scale. At step (f), after step (e), at least some of the product pricing data is sent from the primary food product scale to the secondary food product scale.

### CROSS-REFERENCE TO RELATED APPLICATIONS

This application claims priority to U.S. Provisional Patent Application 60/888,854, filed Feb. 8, 2007, the details of which are incorporated by reference.

### TECHNICAL FIELD

The present application relates generally to networked scales used to weigh food products in supermarkets, and more particularly to a system and method for automatically updating scale database information.

### BACKGROUND

Scales have been used in stores such as supermarkets and groceries to weigh and price food items and to generate a pricing label for such food items. A typical store includes multiple scales located in multiple perishables departments. It is important that weighed items be priced properly and therefore scales are commonly connected into a store network so that the latest pricing information can be provided to the scales in a timely manner. Various types of scale networks exist. The product pricing offered by any given scale is only as accurate as the last pricing updates provided to the scale through the network, and therefore an issue arises when a scale drops offline of the network for some reason as the scale may not receive updated pricing information or when the network is not configured to provide updates to the scale.

### SUMMARY

In an aspect, a method of receiving product pricing errors within a store including multiple food product scales is provided. The method includes (a) providing a store scale communications network. At step (b), a primary food product scale is provided in the store including memory for storing product pricing data. At step (c), a secondary food product scale is provided in the store including memory for storing product pricing data. At step (d), food product pricing data is communicated to the primary food product scale via the communications network and the food product pricing data is stored in memory of the primary food product scale. At step (e), the secondary food product scale identifies a potential internal product pricing data error condition and responsively requests accurate product pricing data from the primary food product scale. At step (f), after step (e), at least some of the product pricing data is sent from the primary food product scale to the secondary food product scale.

In another aspect, a method of updating a food product scale, the scale including a weighing station including an associated mechanism for producing weight indicative signals, and an operator interface screen including a display, is provided. The method includes (a) sending update data to a primary food product scale. The primary food product scale is connected to a store communications network and includes memory for storing the update data. At step (b), a connection is established between a secondary food product scale and the primary food scale over the store communications network after step (a). The secondary food product scale includes a communications interface for receiving the update data when the secondary food product scale is connected to the store communications network and memory for storing the update data. At step (c), the secondary food product scale sends a request to the primary food scale in response to the connection in step (b). At step (d), the update data is sent from the primary food product scale to the secondary food product scale over the store communications network as a response to the request of step (c). The secondary food product scale saves the update data in memory.

Other advantages and features of the invention will be apparent from the following description of particular embodiments and from the claims.

### BRIEF DESCRIPTION OF THE DRAWINGS

FIG. 1 is a perspective view of an embodiment of a food product scale;

FIG. 2 is a schematic illustration of the food product scale of FIG. 1;

FIG. 3 is a schematic diagram of an embodiment of a store including multiple departments;

FIG. 4 is an embodiment of flow chart for synchronizing scale databases;

FIG. 5 illustrates an embodiment of a method for processing changes received by a secondary scale;

FIG. 6 illustrates an embodiment of a method for synchronizing secondary scales;

FIG. 7 illustrates an embodiment of a method for synchronizing a secondary scale coming on-line from an off-line condition; and

FIG. 8 illustrates an embodiment of a method for updating a primary scale coming on-line from an off-line condition.

### DETAILED DESCRIPTION

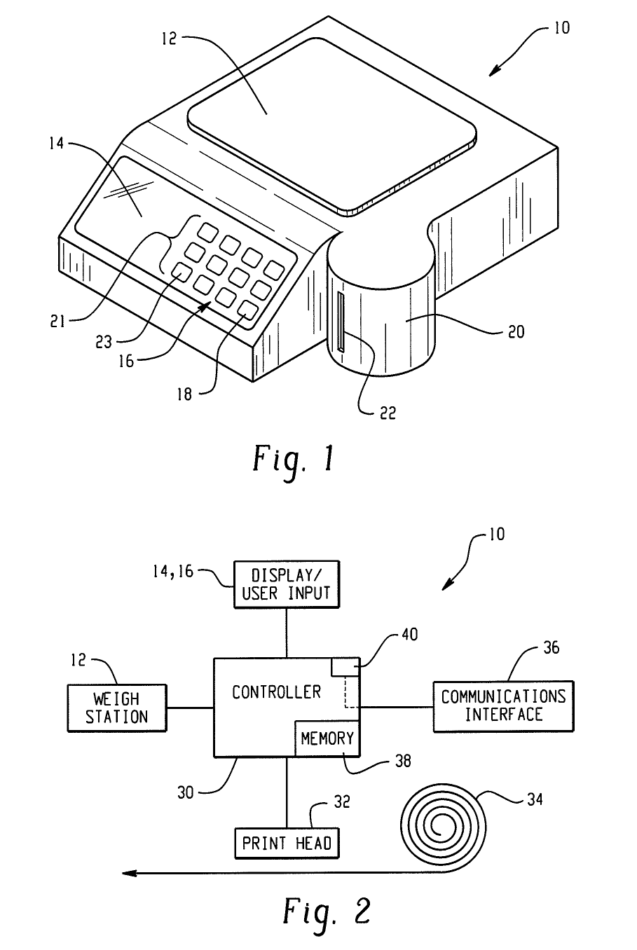

Referring to FIG. 1 an exemplary scale 10 is shown including a weigh station 12 and a display 14. Weigh station 12 may take the form of a platter-type member supported in relationship to a load cell (internal of the scale housing) that produces a weight indicative signal when a food item is placed on the weigh station 12 for weighing. Illustrated display 14 may take the form of an LCD-type display, but other technologies could be used. In the illustrated embodiment the display 14 is a touch screen-type display that also functions as a user input device 16 by displaying image buttons/icons 18 that can be triggered or selected by an operator. The buttons/icons 18 allow for user selection of an item to be weighed from a menu or group 21 of items 23 presented to the user by display 14. In one variation, the group 21 may be a numeric keypad allowing manual entry of product numbers. In another variation, the group 21 may be images of specific products that might be weighed by the scale. A separate operator input device could also be provided, for example, in the form of manually activated keys/buttons located alongside the display 14. A side portion 20 of the scale housing holds a label printer and associated supply of labels, which are dispensed through a label slot 22 in the housing. Although display screen 14 is shown incorporated into the housing of the scale 10, the display could take the form of a marquee-type display located on a support extending upward from the scale housing. In some implementations (e.g., a scale weigh and label system associated with a package wrapping machine for prepack), the display need not be attached to the scale/printer via a support but could be a separately housed console that is logically attached to the scale/printer.

Referring now to FIG. 2, an exemplary schematic of the scale 10 is shown. The scale includes a controller 30, such as a microprocessor based unit, connected to control the display 14 and user input 16 and connected to receive weight indicative signals from the weighing station 12. A print head 32 and associated supply of label stock 34 that can be moved past the print head 32 is also shown. In one example the print head 32 may be a thermal print head for use with thermally activated label stock. However, other types of printing technologies and label media could also be used. The controller 30 is also connected with a communications interface 36, which may take the form of a standard connector (and associated circuitry) for a USB, RS-232, Ethernet or other hard-wired communication line. In another example the communications interface 36 may be formed by a wireless communication device such as an RF transceiver. The communications interface 36 may communicate with other scales over the network. The network may also be connected to the Internet. The illustrated controller 30 includes associated memory 38 for storing product information (e.g., product names, characteristics and pricing stored in association with corresponding product numbers).

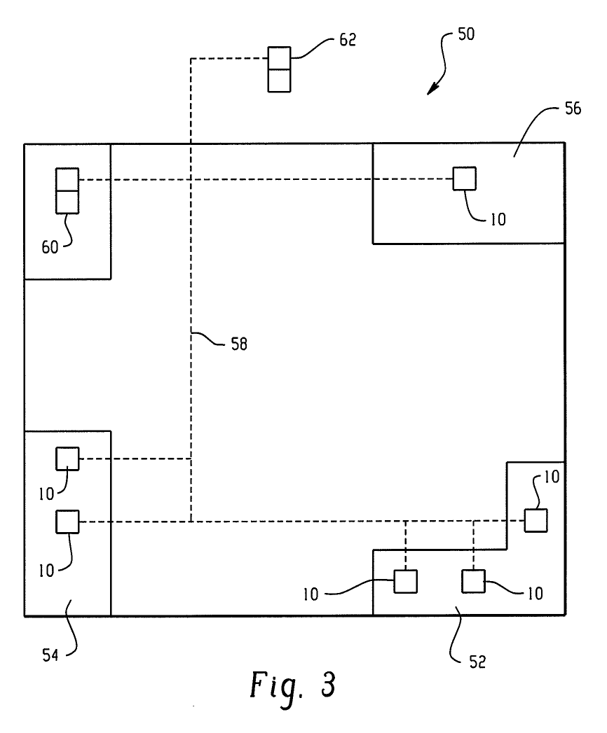

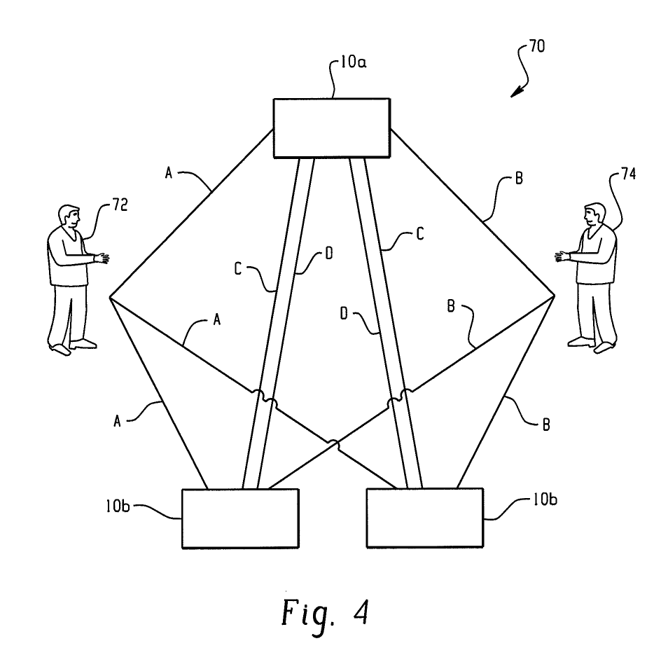

Referring also to FIG. 3, an exemplary store plan 50 is shown with multiple scales 10 in various store perishables departments 52, 54 and 56 (e.g., such as the deli department, the meat and fish department, the bakery department and/or the fruit and vegetable departments), each scale connected to a network 58 for communicating with one of the other scales 10 and/or for communicating a store computer, which may be located in the store as indicated by computer 60 or at a site remote from the store as indicated by computer 62. In a typical store application, each scale receives update data (e.g., price changes, etc.) via the network connection so that the scales are capable of labeling, pricing, tracking, etc. products accurately. The scales may receive the update data directly from a store computer 60 or 62, from one of the other scales or from a location remote from the store (e.g., from headquarters). If a scale goes offline for some reason and fails to receive the latest update data, subsequent use of that scale may result in the use of inaccurate information and thus incorrect pricing, labeling, etc. of one or more products weighed by the scale.

Referring now to FIG. 4, an exemplary flow diagram 70 illustrates a method for consolidating and distributing data so that all the scales 10 receive the latest update information. In the embodiment of FIG. 4, a primary scale 10a is responsible for consolidating and distributing update data pertaining to itself and one or more secondary scales 10b to another or other secondary scales 10b, for example, that missed the update data. As indicated above, update data may be received from a number of sources. Lines identified as A represent operator 72 interaction with a scale that causes changes to the scale's database. Lines identified as B represent updates from a location 74 remote from the scales, such as the store computer. Lines represented as C represent uploading of update data from the secondary scales 10b to the primary scale 10a. Lines represented as D represent the primary scale 10a synchronizing the secondary scales 10b with the update data.

By default, a scale 10 may be configured as a primary scale or as a secondary scale. However, without a secondary scale 10b registered to a primary scale 10a, the primary scale may merely listen passively for update data and update its database when update data arrives. In some embodiments, an operator may change a scale from a primary scale to a secondary scale and vice versa using the user input device 16. In most embodiments, there is a single primary scale 10a for a group of secondary scales 10b. Typically, the secondary scale 10b maintains the primary scale's host name/IP address in order to communicate with the primary scale 10a over the network.

When the primary scale 10a has one or more registered secondary scales 10b, the primary scale stores and maintains any update data in the form of batches received from the remote location 74 or created at either the primary scale or at any of the secondary scales (this will be described in greater detail below). The primary scale 10a also assigns version information to all batches, which orders the batches. During synchronization, the primary scale 10a not only sends the batches of update data to the secondary scales 10b, the primary scale also keeps track of the version information sent to the secondary scales. The next time the primary scale 10a attempts to synchronize a particular secondary scale 10b, the primary scale will first read the version information of the secondary scale to determine which batches of update information to transfer. The secondary scale 10b stores the batches of update data sent by the primary scale 10a, updates its database with each batch as soon as the batch is received and then disposes of the batches. In some embodiments, if one of the batches of update data sent by the primary scale 10a corresponds to a batch stored locally by the secondary scale 10b, the secondary scale will dispose of the batch already saved and replace that batch with the batch sent most recently by the primary scale.

The primary scale 10a may also maintain a list of the secondary scales 10b assigned to it. In some embodiments, the primary scale 10a can purge batches of update data the primary scale maintains when all secondary scales 10b have received a certain batch. As will be described later, the list of secondary scales 10b can also be used to help the primary scale 10a recover from an off-line/off-power condition.

A responsibility of the secondary scale 10b is to notify the primary scale 10a of the presence of local batches of update data. The secondary scale 10b maintains the batches of update data whether they originate locally at the scale or at the remote location. When the secondary scale 10b has stored the update data belonging to a particular batch of update information, the secondary scale 10b notifies the primary scale 10a of the presence of the batch of update data. At the primary scale's request, the secondary scale 10b uploads the batches of update data to the primary scale 10b. Once the batches are uploaded to the primary scale 10a, the batches may be deleted from the secondary scale 10b. As noted above, the primary scale 10a will assign version information to the batch of update information received from the secondary scale 10b, which can then be sent to the all secondary scales during synchronization.

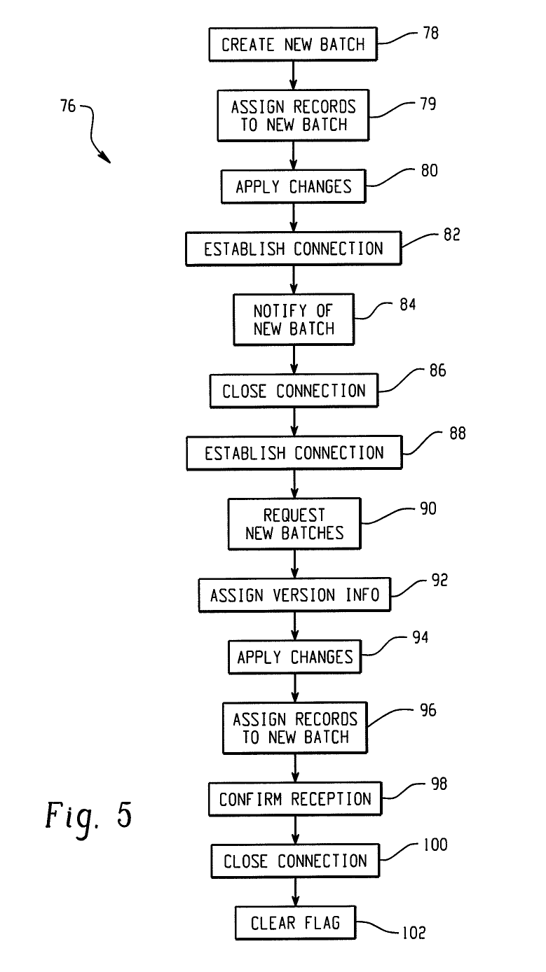

FIG. 5 illustrates a process 76 for processing changes (e.g., by an operator locally at the scale) or uploads (e.g., sent from a remote location) received by the secondary scale 10b. At step 78, a new batch is created by the secondary scale 10b. Each record or command received is assigned to the newly created batch at step 79 and the changes are reflected in the secondary scale's database at step 80. At step 82, the secondary scale 10b establishes a connection with the primary scale 10a using the host name/IP address information. At step 84, the secondary scale 10b notifies the primary scale 10a of the existence of the new batch of update information and the connection is closed at step 86. At step 88, the primary scale 10a establishes a connection with the secondary scale 10b. All batches of update information are requested from the secondary scale 10b at step 90. For each batch uploaded, the primary scale 10a starts a new batch and assigns version information at step 92. For each record received, the primary scale 10a, in some instances, makes the change in its database at step 94 and then assigns the record to the new batch at step 96. At step 98, the primary scale 10a confirms reception of the batch of update information and the connection is closed at step 100. A secondary scale's flag indicating new batch present is cleared at step 102.

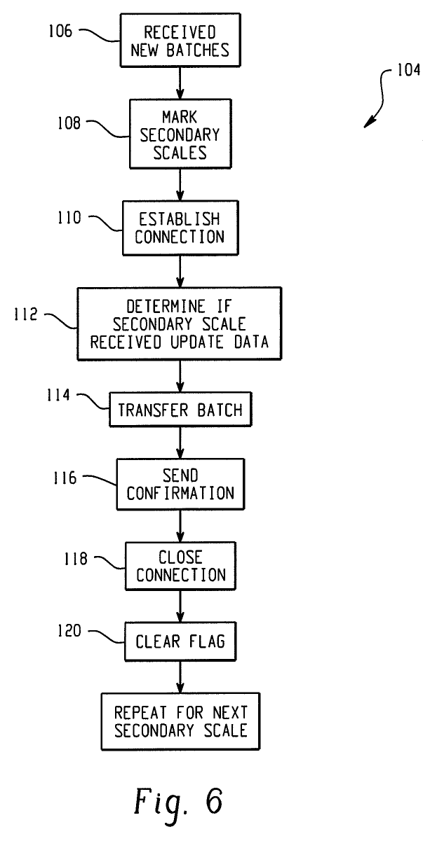

Referring now to FIG. 6, a process 104 is illustrated for synchronizing the secondary scales, for example, with the batch of update information received from one of the secondary scales 10b (see FIG. 5) or with a batch of update information received locally by the primary scale, e.g., from an operator or from the remote location. At step 106, the primary scale 10a determines that it has one or more new batches of update information that it needs to make available to its secondary scales 10b. For each secondary scale 10b marked On-line, the primary scale 10a marks them as Needs Synchronization at step 108. At step 110, the primary scale 10b establishes a connection with one of the secondary scales 10b, indicating a primary scale communication. The primary scale 10a determines whether the secondary scale 10b has received the batch of update data, for example, using version information assigned to the batch at step 112. If the secondary scale 10b has not received the batch, the primary scale 10a transfers the batch of update information to the secondary scale 10b at step 114. At step 116, the secondary scale 10b sends a confirmation message to the primary scale 10a that it received the entire batch. At step 118, the primary scale 10a disconnects from the secondary scale 10b. If the secondary scale 10b is marked Needs Synchronization, a flag is cleared at step 120. If there is another secondary scale 10b marked On-line and Needs Synchronization, the primary scale 10a repeats the above steps for that secondary scale.

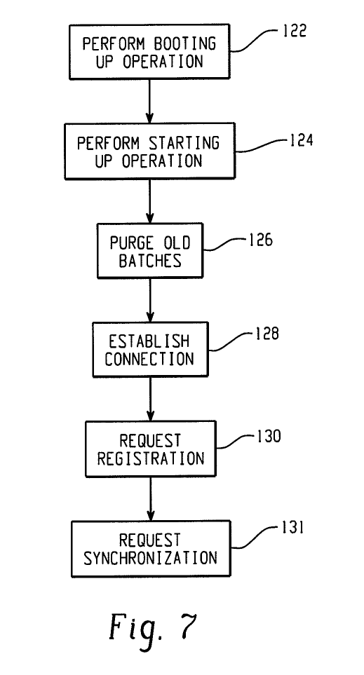

Referring to FIG. 7, the primary scale 10a also updates the secondary scale 10b if the secondary scale goes off-line (e.g., powers down or gets disconnected from the network) and misses update data. If the secondary scale 10b was powered off and then powered on, the secondary scale performs a booting up operation at step 122. The booting up operation can include completing current batches in the secondary scale's database and/or purging incomplete batches. At step 124, the secondary scale 10b performs a starting up operation. The starting up operation can include any necessary initialization. Assuming the secondary scale 10b is connected to the network, it then performs a coming on-line procedure. The on-line procedure may also be performed if the scale is powered on and off-line and then connected to the network. A main purpose of the coming on-line procedure is to synchronize the secondary scale 10b with its primary scale 10a. At step 126, the secondary scale purges any batches older than a preselected period of time, as well as their associated records. If a scale parameter is set to Register, then the secondary scale 10b establishes a connection with the primary scale 10a at step 128, indicating a secondary scale communication and includes the host name/IP address information. At step 130, the secondary scale 10b requests registration with the primary scale 10a, if needed. Once the secondary scale 10b is registered with the primary scale 10a, the secondary scale requests to be synchronized at step 131 with the primary scale in a process similar to that described by FIG. 6.

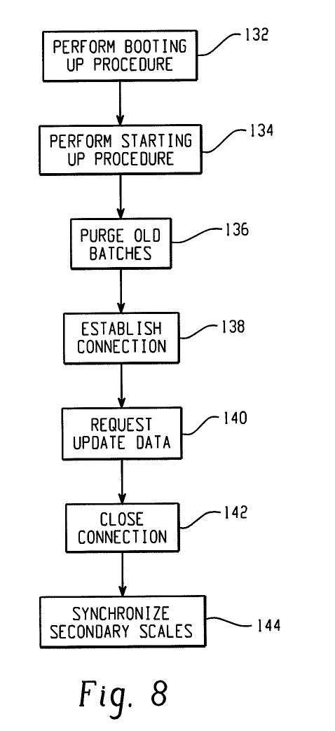

As mentioned above, referring to FIG. 8, in some instances the primary scale 10a may go off-line. In these instances, one or more of the secondary scales 10b may be used to synchronize the primary scale 10a. If the primary scale 10a was powered off and then powered on, the primary scale performs a booting up procedure at step 132. The booting up operation can include completing current batches in the primary scale's database and/or purging incomplete batches. At step 134, the primary scale 10a performs a starting up operation. The starting up operation can include any necessary initialization. Assuming the primary scale 10a is connected to the network, it then performs a coming on-line procedure. The on-line procedure may also be performed if the primary scale is already on and then connected to the network. A main purpose of this coming on-line procedure is to synchronize the primary scale 10a with all its secondary scales 10b. At step 136, the secondary scale purges any batches older than a preselected period of time, as well as their associated records. For each secondary scale 10b, the primary scale 10a attempts to establish a connection with the secondary scale 10b at step 138 indicating a primary scale communication. At step 140, the primary scale 10a requests all batches of update data from the secondary scale 10b not already stored in the primary scale's database. At step 142, once all batches have been transferred from the secondary scale 10b to the primary scale 10a, the connection is closed and the process is repeated for each secondary scale. Then, at step 144, the primary scale 10a synchronizes all secondary scales 10b in a process similar to that described by FIG. 6, which places all the scales in synchrony.

In some embodiments, each department (FIG. 3) contains a primary scale 10a and one or more secondary scales 10b registered with the primary scale. The secondary scales 10b of the department depend on the primary scale 10a of that department for consolidation of data and recovery from off-line conditions. In other embodiments, the scales 10 may be department aware and a single primary scale 10a may be used to synchronize all the secondary scales 10b of the store. In some embodiments, a multi-level hierarchy approach may be used having intermediate scales configured as both primary and secondary scales. As primary scales, the intermediate scales can be responsible for synchronizing their lower secondary scales. As secondary scales, the intermediate scales can be responsible for uploading information to be consolidated at their higher, primary scales.

It is to be clearly understood that the above description is intended by way of illustration and example only and is not intended to be taken by way of limitation. For example, instead of a scale, a printer having many of the features described above except for a weighing station may be connected to the network and be used in synchronizing the scales. The printer may act as a primary printer and may be used to collect and distribute update information to secondary scales in a fashion similar to that described above. Other changes and modifications could be made.

What is claimed is:

1. A method of receiving product pricing updates within a store including multiple food product scales, the method comprising:
(a) providing a store scale communications network;
(b) providing a primary food product scale in the store and including memory for storing product pricing data;
(c) providing a secondary food product scale in the store and including memory for storing product pricing data;
(d) communicating food product pricing data to the primary food product scale via the communications network and storing the food product pricing data in memory of the primary food product scale;
(e) the secondary food product scale identifying a potential internal product pricing data error condition and responsively requesting accurate product pricing data from the primary food product scale; and
(f) after step (e) sending at least some of the product pricing data from the primary food product scale to the secondary food product scale.

2. The method of claim 1 further comprising
assigning version information to the product pricing data in the primary food product scale; and
determining whether the secondary food product scale has accurate product pricing data using the version information.

3. The method of claim 1 further comprising the primary food product scale determining whether the secondary food product scale received the product pricing data stored in the primary food product scale and, if not, then sending the product pricing data to the secondary food product scale.

4. The method of claim 1, wherein step (d) includes sending the product pricing data to the primary food product scale from a remote location.

5. The method of claim 4 further comprising, after step (e) sending update product pricing data to both the primary and secondary food product scales from the remote location over the store communications network.

6. The method of claim 4, wherein the step (d) includes sending the product pricing data to the primary scale from another secondary scale over the store communications network.

7. The method of claim 1, wherein the product pricing data is sent to the secondary food product scale in step (f) as part of a batch.

8. The method of claim 1, wherein the store communications network is connected to the Internet.

9. A method of updating a food product scale, the scale including a weighing station including an associated mechanism for producing weight indicative signals, and an operator interface screen including a display, the method comprising:
(a) sending update data to a primary food product scale, the primary food product scale being connected to a store communications network and including memory for storing the update data;
(b) establishing a connection between a secondary food product scale and the primary food scale over the store communications network after step (a), the secondary food product scale including a communications interface for receiving the update data when the secondary food product scale is connected to the store communications network and memory for storing the update data;
(c) the secondary food product scale sending a request to the primary food scale in response to the connection in step (b); and
(d) sending the update data from the primary food product scale to the secondary food product scale over the store communications network as a response to the request of step (c), the secondary food product scale saving the update data in memory.

10. The method of claim 9 further comprising
assigning version information to the update data in the primary food product scale; and
determining whether the secondary food product scale has received the update information using the version information.

11. The method of claim 9 further comprising the primary food product scale determining whether the secondary food product scale received the update data and, if not, then sending the update data to the secondary food product scale.

12. The method of claim 9, wherein step (a) includes sending the update data to the primary food product scale from a remote location.

13. The method of claim 12 further comprising, after step (b) sending other update data to both the primary and secondary food product scales from the remote location over the store communications network.

14. The method of claim 12, wherein step (a) includes sending the update data to the primary scale from another secondary scale over the store communications network.

15. The method of claim 9, wherein the update data is sent to the secondary food product scale in step (d) as part of a batch.

16. The method of claim 9, wherein the update data comprises food pricing information.

17. The method of claim 9, wherein the store communications network is connected to the Internet.

18. The method of claim 1, wherein the step of establishing the connection between a secondary food product scale and the primary food scale over the network includes the secondary food product scale performing a start-up operation.
